(19) United States
(12) Patent Application Publication
(10) Pub. No.: US 2003/0054780 A1
(43) Pub. Date: Mar. 20, 2003

(54) High frequency power amplifying circuit, and mobile communication apparatus using it

(75) Inventors: Yasuhiro Nunogawa, Takasaki (JP); Tetsuaki Adachi, Toubumachi (JP)

Correspondence Address: MATTINGLY, STANGER & MALUR, P.C., Suite 370, 1800 Diagonal Road, Alexandria, VA, 22314, US

(73) Assignee: Hitachi, Ltd.

(21) Appl. No.: 10/277,663

(22) Filed: Oct. 23, 2002

Related U.S. Application Data
(63) Continuation of application No. 09/555,010, filed on Sep. 5, 2000.
Application No. 09/555,010 is a 371 of international application No. PCT/JP97/04356, filed on Nov. 28, 1997.

(51) Int. Cl. H04B 1/04

(52) U.S. Cl. 455/127

(57) ABSTRACT

A high frequency power amplifying circuit in which a first amplifying element and a second amplifying element of the same structure as the above first amplifying element and being reduced to 1/M in element size are used, the above first amplifying element and the second amplifying element are supplied with the same bias voltage from a power control circuit, and the power output of the above first amplifying element is judged based on the output current outputted from the output terminal of the above second amplifying element.

### TECHNICAL FIELD

The present invention relates to a high frequency power amplifying circuit and a mobile communication apparatus using it, and more particularly to a technology for use in the control of high frequency power in a battery-powered high frequency power amplifying circuit and a mobile communication apparatus using it.

### BACKGROUND ART

A high frequency power amplifying circuit (RF power amplifying IC) for use in a mobile communication apparatus is described “Nikkei Electronics”, Nikkei McGraw-Hill Company, pp. 115-126, 27th January, 1997.

To detect a high frequency power for transmission power control in a mobile communication apparatus, a power coupler is used or the power current of the high frequency power amplifying circuit is sensed. When the power coupler is used, a part of the transmission radio wave is drawn for detection. Therefore, the insertion loss becomes as large as 0.2-0.3 dB, decreasing the transmission efficiency. When the power current is sensed, a resistor element inserted, in series, into the power supply line of the high frequency power amplifying circuit decreases the power voltage when the output power is large. This decreases the battery voltage efficiency and shortens the battery life. Another problem in both sensing methods described above is that, in an area where the output power is low, the sense output decreases accordingly and, therefore, low-power control cannot be made precisely.

Therefore, it is an object of the present invention to provide a high frequency power amplifying circuit, capable of precisely detecting the power in a wide power range while maintaining high transmission efficiency, and a mobile communication apparatus using the circuit. It is another object of the present invention to provide a high frequency power amplifying circuit capable of operation even at a low voltage and a mobile communication apparatus using it. The above and other objects and the novel features of the present invention will become apparent from the description of the specification and the attached drawings.

### DISCLOSURE OF INVENTION

A high frequency power amplifying circuit according to the present invention uses a first amplifying element and a second amplifying element of the same structure as the above first amplifying element and being reduced to 1/M in element size. The above first amplifying element and the second amplifying element are supplied with the same bias voltage from a power control circuit, and the power output of the above first amplifying element is judged based on the output current outputted from the output terminal of the above second amplifying element.

### BRIEF DESCRIPTION OF DRAWINGS

FIG. 1 is a block diagram showing one embodiment of a mobile communication apparatus using a high frequency power amplifying circuit according to the present invention.

FIG. 2 is a basic circuit diagram showing one embodiment of the high frequency power amplifying circuit according to the present invention.

FIG. 3 is a basic circuit diagram showing another embodiment of the high frequency power amplifying circuit according to the present invention.

FIG. 4 is a characteristics diagram, used to describe an example of the operation of the high frequency power amplifying circuit according to the present invention, showing the relation between the output power and detected current.

FIG. 5 is a characteristics diagram, used to describe another example of the operation of the high frequency power amplifying circuit according to the present invention, showing the relation between the output power and detected current.

FIG. 6 is a circuit diagram showing yet another embodiment of the high frequency power amplifying circuit according to the present invention.

FIG. 7 is a basic configuration diagram showing another embodiment of the high frequency power amplifying circuit according to the present invention.

FIG. 8 is a circuit diagram showing yet another embodiment of the high frequency power amplifying circuit according to the present invention.

FIG. 9 is a circuit diagram showing yet another embodiment of the high frequency power amplifying circuit according to the present invention.

FIG. 10 is a characteristics diagram, used to describe an example the operation of the high frequency power amplifying circuit according to the present invention, showing the relation between the output power and detected current.

FIG. 11 is a circuit diagram showing yet another embodiment of the high frequency power amplifying circuit according to the present invention.

FIG. 12 is a block diagram showing yet another embodiment of the high frequency power amplifying circuit according to the present invention.

FIG. 13 is an entire block diagram showing an embodiment of a mobile communication apparatus using the high frequency power amplifying circuit according to the present invention.

### BEST MODE FOR CARRYING OUT THE INVENTION

Some embodiments of the present invention will be described in detail with reference to the attached drawings.

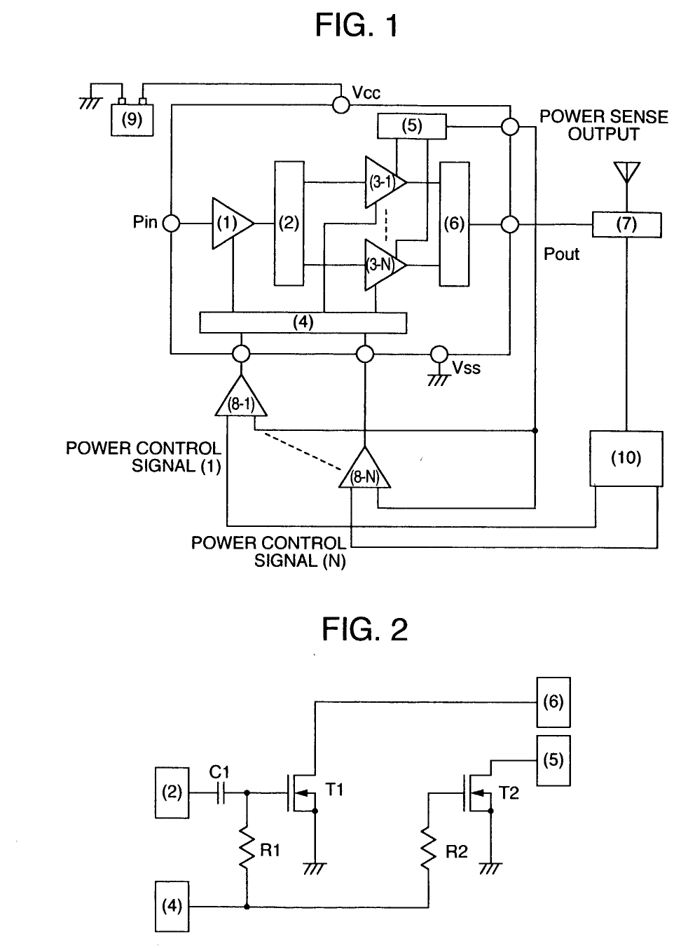

FIG. 1 is a block diagram showing an embodiment of a mobile communication apparatus using a high frequency power amplifying circuit according to the present invention. Though not necessarily required, a lithium ion battery is used for the power supply to the mobile communication apparatus. As it is well known, the voltage of the lithium ion battery is as low as 3.6V. To obtain a high frequency power amplifying output at this low voltage and to minimize the power consumption, a power control circuit and a circuit for sensing a high frequency power output described below are provided.

An input signal Pin is supplied to an input terminal of an input stage amplifier (1). At an output of the input stage amplifier (1) is provided a power distribution circuit (2). The power distribution circuit (2) distributes a signal output from the input stage amplifier (1) to a plurality of output stage amplifiers (3-1) to (3-N) and, at the same time, performs impedance matching between the stages.

Output terminals of the output stage amplifiers (3-1) to (3-N) described above are connected to an output matching circuit (6). The output matching circuit (6) also has a function to combine output signals from the output stage amplifiers (3-1) to (3-N). A signal output from the output matching circuit (6) is sent to an antenna via a duplexer (7) for transmission as radio waves.

A gain control circuit (4) generates a bias voltage for controlling gains of the input stage amplifier (1) and the output stage amplifiers (3-1) to (3-N).

An input signal received by the antenna is sent to a receiving circuit (10) via the duplexer (7). The received signal includes a signal from a sending apparatus and a control signal indicating an electric field strength of the radio wave from a base station. The receiving circuit (10) decodes the control signal, generates power control signals (1) to (N), and sends them to power control amplifiers (8-1)-(8-N).

A power sense element composed of an amplifier element, whose size is 1/M of the amplifier element generating the output signal Pout, is provided in each of the output stage amplifiers (3-1) to (3-N). The bias voltage described above is applied to the input of the power sense element to control the gain of the output, though not limited thereto.

Output signals from the power sense elements are combined by a detected-current combining circuit (5). The resulting combination signal is then sent to the power control amplifier (8-1)-(8-N) as a power sense output.

As will be described later, the input stage amplifier (1) and the output stage amplifiers (3-1) to (3-N) include amplifying MOSFETs in a grounded-source configuration with their gates serving as inputs. The output signals are obtained from their drains.

The input stage amplifier (1) and the output stage amplifiers (3-1) to (3-N) perform class “AB”amplification. They act as variable gain amplifiers that increase the mutual conductance gm and the gain as the gate voltage increases. In the description of the present invention, the MOSFET is intended to mean not only metal oxide field effect transistors but also metal insulator semiconductor (MIS) FETs. The gate electrode of the MOSFET and the MISFET includes not only metal but also conductive polysilicon for high frequency operation.

This embodiment is intended for the GSM(Global System for Mobile Communication) system. The GSM system, well known as the European standard for digital mobile telephones, uses the TDMA(time division multiple access) and FDD(frequency division duplex) technologies at a carrier frequency of 900 MHz. For modulation, GMSK(Gaussian filtered minimum shift keying) is employed.

The GSM system, in which each two base stations can be up to 10 miles (about 16 Km) apart, requires that the output be controlled by a mobile telephone in a range from 13 dBm to 43 dBm in steps of 2 dB. The output control method of the GSM system always controls the transmission output of a mobile telephone. That is, a mobile telephone controls its output according to the control signal sent from the base station periodically.

Referring to FIG. 1, when the control signal is received by the antenna, one of power control signals (1)-(N) is selected by an output control circuit included in the receiving circuit (10). This power control signal, with a pulse duty factor corresponding to the time division, is a pulse signal with its peak corresponding to the voltage of the output power. It should be noted that the rise and the fall of the pulse is controlled so that the slope becomes gradual. The digital/analog converter is used to control the slope of this rise and fall so that the signal rises and falls in response to the clock signal.

One of the power control amplifiers (8-1) (8-N) receives the power control signal, generates the bias voltage so that the power control signal matches the power sense output, and controls the output power Pout of one of the output stage amplifiers (3).

In this embodiment, in order to control a wide range of output power simply and precisely, the setting range of 13 dBm-43 dBm is divided, for example, into three (when N=3) and assigned to: a small output amplifier (3-1), a medium output amplifier (3-2), and a large output amplifier (3-3). In response to the signal from the base station specifying a medium output range, the receiving circuit (10) generates the power control signal (2) to activate only the power control amplifier (8-2). The power control signals (1) and (3) sent to the power control amplifiers (8-1) and (8-3) are set to zero to inactivate the bias voltage of the corresponding output stage amplifiers (3-1) and (3-3).

The power control signal (2) rises along the slope described above to a constant voltage corresponding to the peak power and, after a transmission time allocated according to the time division, falls along the similar slope. Because the bias voltage varies to make the power control signal (2) equal to the sense output, not only the peak power but also the slope of the rise and the fall of the transmission output can be controlled precisely.

When the control signal from the base station specifies a small output range or a large output range, the receiving circuit generates the power control signal (1) or (3) to activate only the power control amplifier (8-1) or (8-3) and inactivates other amplifiers. Selectively using the three output stage amplifiers in this manner makes possible highly efficient output and highly sensitive sense output.

FIG. 2 is a circuit diagram showing one embodiment of the output stage amplifier according to the present invention. The output stage amplifier comprises an output MOSFET(T1) and a sense MOSFET(T2) that is 1/M of the MOSFET(T1) in size. The sources of the MOSFET(T1) and the MOSFET(T2) are at the ground potential, and the bias voltages are supplied from the gain control circuit (4) via resistors R1 and R2, respectively. A signal component is supplied to the gate of the output MOSFET(T1) via the power distribution circuit (2) and a coupling capacitor C1.

As described above, the gain of the MOSFET(T1) is determined by the mutual conductance gm corresponding to the DC bias voltage supplied to the gate. Therefore, the sense MOSFET(T2), to which the same bias voltage is supplied, can generate the 1/M output of the output power of MOSFET(T1) from its drain as the sense output.

Because all output signal generated by the output MOSFET(T1) is outputted as a transmission signal in this configuration, a high power transmission output may be obtained even at a low voltage. The sense output may be set according to 1/M. Thus, when the maximum output power of the output MOSFET(T1) is relatively small, 1/M is increased (M is decreased). Conversely, when the maximum output power of the output MOSFET(T1) is relatively large, 1/M is decreased (M is increased). In this way, the highly-sensitive sense output best suited for circuit control may be obtained according to the required output power.

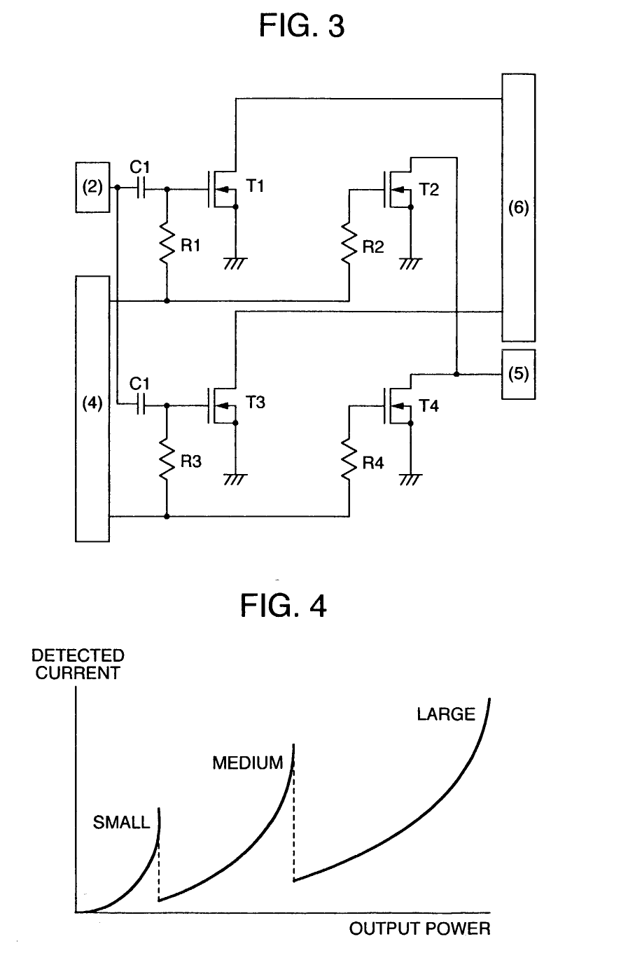

FIG. 3 is a circuit diagram showing another embodiment of the output stage amplifier according to the present invention. In this embodiment, two output stage circuits are used to increase the output range.

In this embodiment, the output power range is divided into two. An output MOSFET(T1) is composed of a relatively small-sized MOSFET to cover a small-output power area. On the other hand, an output MOSFET(T3) is composed of a relatively large-sized MOSFET to cover a large-output power area. In this embodiment, a sense MOSFET(T2) is paired with the output MOSFET(T1), and a sense MOSFET(T4) with the output MOSFET(T3). That is, there is a one to one correspondence between the output MOSFET and the sense MOSFET.

A bias voltage is supplied from the power control circuit (4) to the gates of the output MOSFET(T1) and the sense MOSFET(T2) via the resistors R1 and R2. Similarly, another bias voltage is supplied from the power control circuit (4) to the gates of the output MOSFET(T3) and the sense MOSFET(T4) via the resistors R3 and R4. The input signal is supplied to the gates of the output MOSFETs(T1)and (T3) via the coupling capacitors C1 and C2, and one of the drain outputs of the output MOSFETs(T1) and (T3) is selected via the matching circuit (6) for output. On the other hand, the drains of the sense MOSFETs(T2) and (T4) are connected in common, and the drain output activated by the bias voltage is outputted from the common sense output terminal.

In this configuration, two output MOSFETs(T1) and (T3) are used for the output range. Therefore, the characteristics of the bias voltage and the output power which have a higher output efficiency may be used.

FIG. 4 is a characteristics diagram of the relation between the detected current and the output power. This figure is used to describe an example of the power control method in which a plurality of MOSFETs, each having its own output capacity as described above, are used. In the figure, the output power range is divided into three: small power, medium power, and large power.

Three output stage amplifiers are provided to cover the output power range. To allow the output power to change smoothly from small power to large power, the amplifier is changed to the medium power output stage amplifier when the power range is not covered by the small power output stage amplifier. Similarly, the amplifier is changed to the large power output stage amplifier when the power range is not covered by the medium power output stage amplifier. Conversely, when the sense current is small for the large power output stage amplifier and when a medium power output that cannot be controlled accurately by a bias voltage with such a small sense current is indicated, switching is made to the medium power output stage amplifier.

In the GSM system, the output control signal is sent from the base station to a mobile telephone periodically. Because the output stage amplifiers are switched between the output operations performed on a time division basis, no serious problem is generated during the power control operation described above.

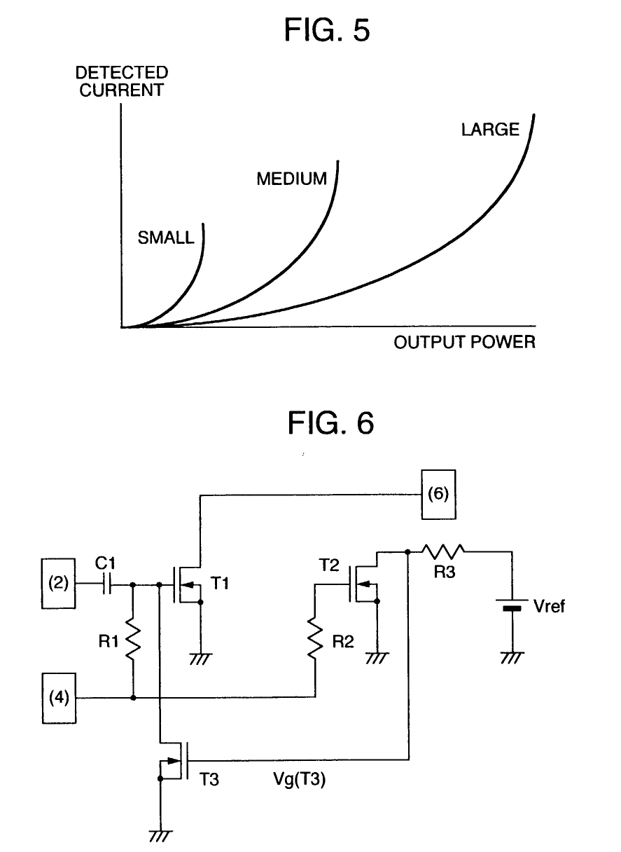

FIG. 5 is a characteristics diagram showing the relation between the detected current and the output power. This figure is used to describe an example of power control method in which a plurality of MOSFETs, each having its own output capacity as described above, are used. In the figure, the output power range is divided into three: small power, medium power, and large power.

In this embodiment, one of three output stage amplifiers is selected based on the output control signal first specified at the start of communication by the base station for a mobile telephone. During the communication, output control is performed by the selected output stage amplifier. Because the output stage amplifiers are not switched in this configuration, the control of output stage amplifiers is simple. In general, because there is no considerable change in the output power of a mobile telephone during communication, the control method described above virtually presents no serious problem. That is, one of the small, medium, and large power output stage amplifiers is selected in consideration of an output power range covering output powers somewhat smaller than and somewhat larger than the output power specified by the base station for a mobile telephone at the start of communication.

FIG. 6 is a circuit diagram showing another embodiment of an output stage amplifier according to the present invention. In this embodiment, an automatic switching function for operating a plurality of output stage MOSFETS at the same time is provided. That is, the output stage amplifier in this embodiment has an additional self-shutdown circuit.

Referring to the figure, one of the plurality of output stage amplifiers is shown as a representative amplifier. A plurality of output MOSFETs(T1) of the similar output stage amplifiers are connected in parallel via the output matching circuit (6). For example, in the circuit shown in FIG. 1, the receiving circuit supplies, at its maximum output time, the power control signal to the power control amplifiers (8-1)-(8-N) to activate all output stage amplifiers (3-1) to (3-N). The resistor R3 is provided between the drain of a sense MOSFET(T2) and a reference voltage Vref. The drain output voltage of the sense MOSFET(T2) is supplied to the gate of a shutdown MOSFET T3. The drain-source path of this MOSFET(T3) connects the gate to the source (ground potential of the circuit) of the output MOSFET(T1).

As the bias voltage is reduced by the specified output control signal, drain current flowing through the sense MOSFET(T2) is reduced. This reduced drain current reduces the voltage drop across the resistor R3 and increases the gate voltage of the MOSFET(T3). When the gate voltage of the MOSFET(T3) becomes equal to or larger than the threshold voltage, the MOSFET(T3) is turned on and the output MOSFET(T1) is turned off. This inactivates the output MOSFET(T1), and the output operation of the other output MOSFETs, not shown, serves to generate the output signal.

Combined use of the size of the sense MOSFETs, each 1/M of the output MOSFET, and the setting of the resistance of the resistor R3 decides the threshold voltage of the shutdown MOSFET. Based on the thereshold voltage of the shutdown MOSFET, the output MOSFET is predefined, for example, for each of the small power area, the medium power area, and the large power area to activate the self-shutdown circuit in order to switch the output power. The additional self-shutdown circuit cuts off the input signal to an inactive output MOSFET, thus reducing the output leakage.

In the above case, the plurality of output MOSFETs may be of the same size or their sizes may be determined with predetermined weights.

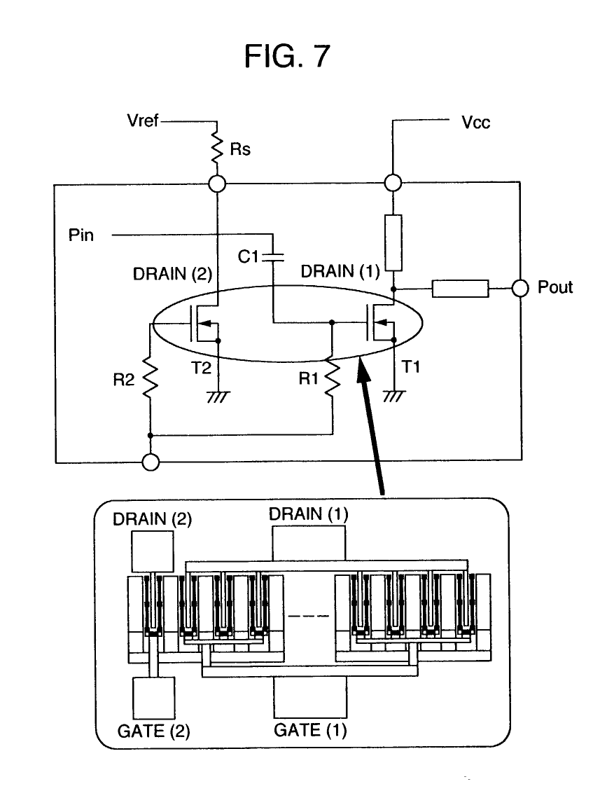

FIG. 7 is a diagram showing a basic configuration of one embodiment of a high frequency power amplifying circuit according to the present invention. The figure shows an output stage amplifier circuit including an output MOSFET and a sense MOSFET as well as an element pattern corresponding to the circuit.

The output stage amplifier includes the output amplifying MOSFET(T1), sense MOSFET(T2), resistors R1 and R2 for transferring the gain control bias voltage to the gates of the MOSFETs(T1) and (T2), and the coupling capacitor C1 for transferring the input signal Pin to the gate of the output MOSFET(T1). A load resistor is provided between the Drain(1) of the output MOSFET(T1) and a power voltage Vcc. A sense resistor Rs is provided and connected to the Drain (2) of the sense MOSFET(T2) for conversion of a the current detected by the sense MOSFET(T2) to a voltage signal.

In the sense MOSFET(T2), a thin drain is formed between a pair of source areas indicated by thick vertical hatching areas as shown in the pattern diagram. A pair of gate electrodes, indicated by black areas, are provided between the source area and the drain area. The two gate electrodes are connected to the gate line Gate(2) shown at the bottom. The drain area formed between the two gate electrodes is connected to the drain line Drain (2).

On the other hand, the output MOSFET(T1) includes M sets of the source, drain and gate electrodes arranged horizontally. When the gate-source voltage is equal, the drain current flowing through the output MOSFET(T1) is M times as large as the drain current flowing through the sense MOSFET(T2) because of this configuration. In other words, the current flowing through the sense MOSFET(T2) is 1/M of the output direct current flowing through the output MOSFET(T1). Because the drain current flowing through the output MOSFET(T1) corresponds to the transmission output power, the drain current flowing through the sense MOSFET(T2) also corresponds to the transmission output power.

The source area of the sense MOSFET(T2) and M sets of horizontally-arranged source areas of the output MOSFET(T1) are connected. They are at the ground potential of the circuit.

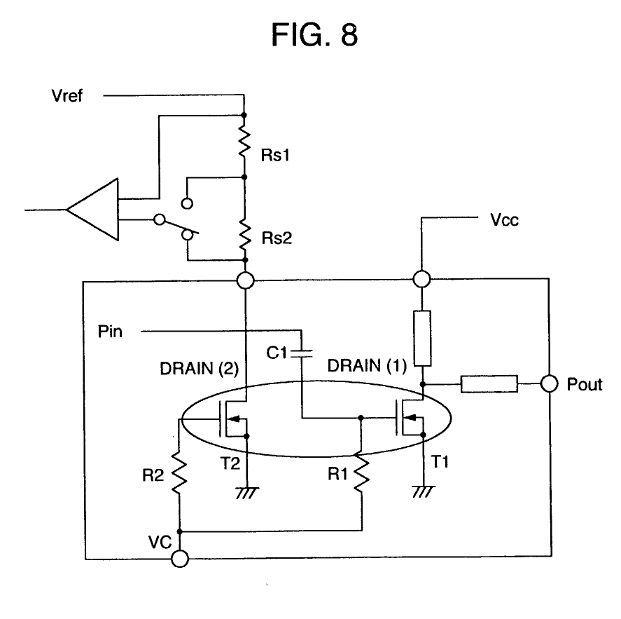

FIG. 8 is a circuit diagram showing another embodiment of a high frequency power amplifying circuit according to present invention. In this embodiment, the sensitivity may be changed. That is, in an output stage amplifier similar to the one shown in FIG. 7, a sense resistor connected to the drain line Drain(2) of the sense MOSFET(T2) comprises two resistors, Rs1 and RS2, connected in series. To obtain the sense output, a switch is provided to supply the voltage developed either across the resistors Rs1 and Rs2 connected in series or across the resistor Rs1 to the amplifying circuit as the sense signal.

In an area where the output power of the output MOSFET(T1) is small, the current flowing through the drain of the sense MOSFET(T2) becomes small accordingly. In this case, the switch is operated to use a large voltage developed across the resistors Rs1 and Rs2 connected in series.

In an area where the output power of the output MOSFET(T1) is large, the current flowing through the drain of the sense MOSFET(T2) becomes large accordingly. In this case, the switch is operated to use a voltage, developed across the resistor Rs1 only, as the sense voltage. Switching the sense voltage according to the output power in this manner allows a highly-sensitive sense output to be generated. However, it should be noted that the resistor switching like this requires the level of the power control signal to be switched accordingly.

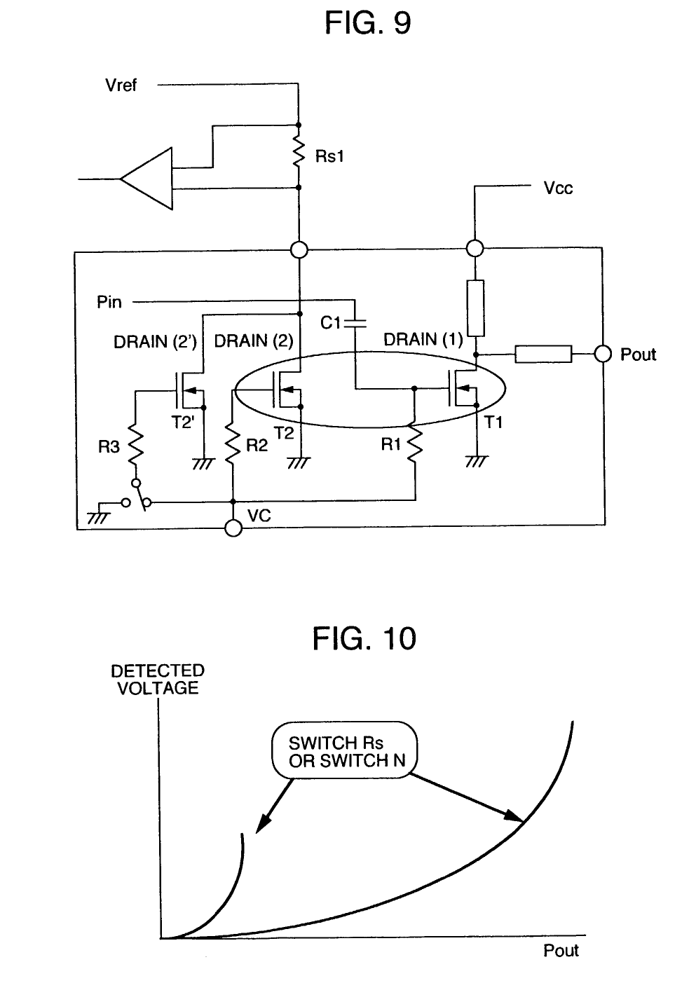

FIG. 9 is a circuit diagram showing a still another embodiment of a high frequency power amplifying circuit according to the present invention. This embodiment also allows the sensitivity to be switched. That is, two sense MOSFETs(T2) and (T2′) are provided in an output stage amplifier similar to the one shown in FIG. 7. The drain lines, Drain(2) and Drain(2′), of the sense MOSFETs(T2) and (T2′) are connected to the sense resistor Rs1. The voltage of the gate of the added sense MOSFET(T2′) is changed over by a switch, connected via the gate input resistor R3, between the gain control bias voltage and the ground potential of the circuit. This configuration allows one of two sense currents to be obtained: sense current generated by the output MOSFET(T1) or the sense current doubled by the added sense MOSFET(T2′).

In an area where the output power of the output MOSFET(T1) is small, the current flowing through the drain of the sense MOSFET(T2) becomes small accordingly. In this case, the switch is operated to generate the double current by supplying the bias voltage also to the sense MOSFET(T2′).

In an area where the output power of the output MOSFET(T1) is large, the current flowing through the drain of the sense MOSFET(T2) becomes large accordingly. In this case, the switch is operated to turn off the sense MOSFET(T2′) by supplying the ground potential to its gate. This allows the sense current generated only by the sense MOSFET(T2) to flow into the sense resistor Rs1. Switching the sense current according to the output power in this manner allows a highly-sensitive sense output to be generated. However, it should be noted that the switching of the sense MOSFET(T2′) described above requires the level of the power control signal to be switched accordingly.

FIG. 10 is a characteristics diagram showing the relation between the output power and the detected current. This figure describes an example of the operation of the high frequency power amplifying circuit according to the present invention. This characteristics diagram corresponds to the operation of the high frequency power amplifying circuit shown in FIG. 8 and FIG. 9. The switch Rs for insertion of the series-connected sense resistor Rs2 or the switch N for addition of the sense MOSFET(T2′) serves to maintain high sensitivity even in a small power area as in a large power area.

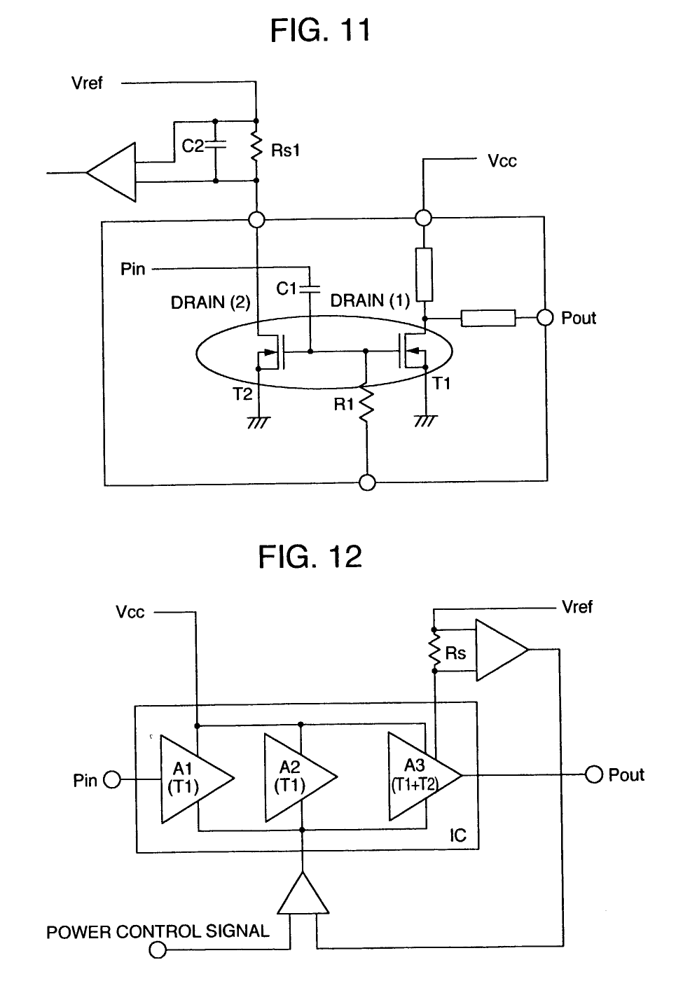

FIG. 11 is a circuit diagram of a still another embodiment of a high frequency power amplifying circuit according to the present invention. In this embodiment, the input signal Pin is supplied also to the sense MOSFET(T2). That is, the gate of the output MOSFET(T1) and the gate of the sense MOSFET(T2), which are connected, receive the gain control bias voltage via the resistor R1. The input signal Pin is supplied to the gates of the output MOSFET(T1) and the sense MOSFET(T2) via the coupling capacitor C1. This configuration causes the signal component to flow into the drain output of the sense MOSFET(T2). This signal is smoothed by a capacitor, provided in parallel to the sense resistor Rs1, to generate a sense voltage more accurately proportional to the drain power of the output MOSFET(T1).

FIG. 12 is a block diagram of a still another embodiment of a high frequency power amplifying circuit according to the present invention. In this embodiment, a three-stage amplifier configuration, composed of a first-stage amplifier A1, a next-stage amplifier A2, and an output stage amplifier A3, is used to provide a high gain in the high frequency power amplifying stage. In this case, the first-stage amplifier A1 and the next-stage amplifier A2 each comprise an amplifying MOSFET only, while only the output stage amplifier A3 comprises the output MOSFET(T1) and the sense MOSFET(T2). The gain control bias voltage generated based on the signal detected by the sense MOSFET(T2) in the output stage amplifier is supplied to the first-stage amplifier A1, the next-stage amplifier A2, and the output stage amplifier A3.

In this configuration, the whole power control, including compensation for manufacturing process variations in the first-stage amplifier A1 and the next-stage amplifier A2, may be performed based on the output sense voltage from the largest-power output stage amplifier and the power control corresponding thereto. Because the output signal from the MOSFETs in the first-stage amplifier A1 and the next-stage amplifier A2 is small, the MOSFET size may be determined according to the output level.

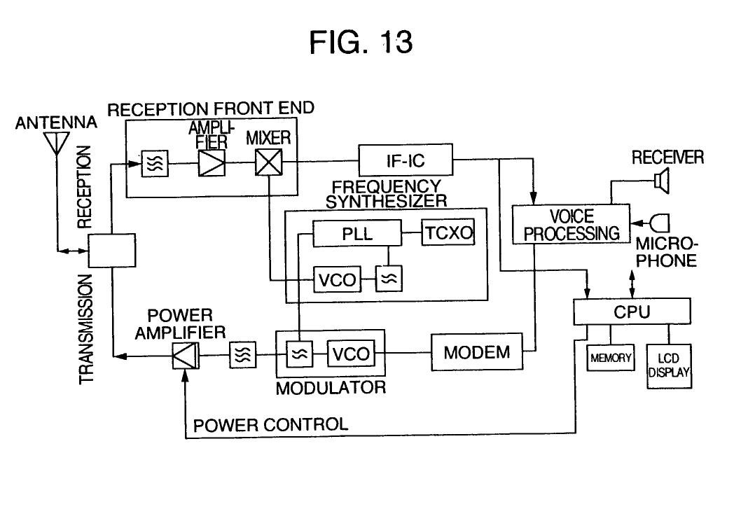

FIG. 13 is an entire block diagram showing an embodiment of a mobile communication apparatus according to the present invention. A most typical example of the mobile communication apparatus is a mobile telephone.

The signal received by the antenna is amplified by the receiving front end, converted by the mixer into an intermediate frequency wave, and transferred to the voice processing circuit via the intermediate signal processing circuit IF-IC. The gain control signal periodically included in the received signal is processed, for example, as described below. That is, the gain control signal is decoded by the microprocessor CPU, the power control signal composed of pulses according to the pulse duty factor corresponding to the time division is generated, and the generated signal is transferred to a high frequency power amplifying circuit such as the one according to the present invention, for performing the power control of transmission output.

The frequency synthesizer generates the oscillation signal, corresponding to the received frequency, using the reference oscillation circuit TCXO, voltage control oscillation circuit VCO, and the PLL loop and, at the same time, transfers the oscillation signal to the mixer in the reception front end. The oscillation signal is also fed to the modulator.

In the voice processing circuit, the received signal activates the receiver for generation of a voice signal. The transmission voice is converted to an electrical signal by the microphone and transferred to the modulator via the voice processing circuit and the modem.

The embodiments described above have the following effects:

(1) A first amplifying element and a second amplifying element of the same structure as the above first amplifying element and being reduced to 1/M in element size are used, the above first amplifying element and the second amplifying element are supplied with the same bias voltage from a power control circuit, and the power output of the above first amplifying element is estimated based on the output current outputted from the output terminal of the above second amplifying element. This high frequency power amplifying circuit can precisely detect the power in a wide power range while maintaining high transmission efficiency.

(2) There are a plurality of first amplifying elements and the number of first amplifying elements to be activated in parallel in response to control signals from said power control circuit is increased or decreased. This configuration allows the high frequency power amplifying circuit to efficiently cover a wide range of output power.

(3) There are a plurality of said first amplifying elements, each having its own size, and one of said plurality of said first amplifying elements is selectively activated in response to an output control signal corresponding to a control signal from said power control circuit. This configuration allows the high frequency power amplifying circuit to efficiently cover a wide range of output power.

(4) There are a plurality of second amplifying elements, each corresponding to one of first amplifying elements, and the plurality of second amplifying elements are activated in parallel to output sense signals in accordance with first amplifying elements activated in response to the control signals from the power control circuit. This configuration allows the sense output signal to be output corresponding to the output power switching.

(5) There are a plurality of second amplifying elements, each corresponding to one of first amplifying elements, and the second amplifying element corresponding to one of first amplifying elements activated in response to the control signal from said power control circuit is activated. This configuration allows the sense signal to be output corresponding to the output power switching.

(6) The first amplifying elements and the second amplifying elements are formed on the same semiconductor substrate. This allows the sense output signal to be generated precisely without being affected by process variations.

(7) The output current output from the output terminal of the second amplifying element selectively flows through a plurality of series resistors under control of a switch controlled by the output current detection sensitivity switching signal. This configuration allows high sensitivity to be maintained even in a small power area as in a large power area.

(8) There are a plurality of second amplifying elements whose output terminals are connected, and the control signal is selectively supplied under control of a switch controlled by the output current sensitivity switching signal. This configuration allows high sensitivity to be maintained even in a small power area as in a large power area.

(9) The input signal supplied to the input of the first amplifying element is supplied also to the input terminal of the second amplifying element, and the output current of the second amplifying element changes the input signal to a direct current for use as the detection current. This enables power to be controlled precisely.

(10) The first amplifying element constitutes an output stage amplifier of a multi-stage amplification circuit whose preceding stages are composed of one or more vertically connected amplifiers, the second amplifying element is provided corresponding to the first amplifying element constituting the output stage amplifier, and the control signal generated by the power control circuit is supplied to the amplifiers vertically connected in the stages. This simple configuration allows output power control, including compensation for manufacturing process variations in the preceding stages, to be performed.

(11) The high frequency power MOSFET, used in the first amplifying element and the second amplifying element, eliminates the need for a negative voltage which would be required for a GaAs MOSFET. Because of this, the circuit is easy to use and, in addition, may be operated by a low voltage battery such as a lithium ion battery.

(12) Applying this invention to a battery-operated high frequency power amplifying circuit prolongs the battery life. In other words, the circuit may be used for communication longer on one battery charge.

(13) controlling the high frequency power amplifying circuit according to the present invention with the use of the control signal included in the signal received from the base station and operating an electronic circuit, such as a reception/transmission circuit or a control circuit including the high frequency power amplifying circuit, make available a mobile communication apparatus that may be used longer on one battery charge.

(14) Using a lithium ion battery as the battery described above makes available a compact, lightweight mobile communication apparatus that may be used longer on one battery charge.

While the preferred embodiments of the invention invented by the inventor have been described, it is to be understood that the present invention is not limited to the embodiments but that modifications will be apparent to those skilled in the art without departing from the spirit of the present invention. Any digital mobile telephone may be used as long as its output power is controlled by the control signal from the base station such as a telephone in the CDMA (code division multiple access) system. For example, in the CDMA system, power control is performed through accurate feedback from the base station to a mobile telephone. In addition, in a system such as the IS-136 system or AMPS system where output power control is not so important, the high frequency power amplifying circuit according to the present invention increases transmission efficiency. The mobile communication apparatus is not limited to an apparatus such as a telephone that sends and receives voice signals. The mobile communication apparatus may also be an apparatus that converts digital signals to signals in the voice signal frequency band for sending digital signals to, and receiving digital signals from, personal computers or other similar mobile communication apparatuses via a digital telephone exchange network.

Industrial Applicability

As described above, the present invention may be applied widely to a high frequency power amplifying circuit and a mobile communication apparatus using it.

1. A high frequency power amplifying circuit comprising:
a first amplifying element;
a second amplifying element of the same structure as said first amplifying element, an element size of said second amplifying element being 1/M of said first amplifying element; and
a power control circuit supplying an identical bias voltage to said first amplifying element and said second amplifying element,
wherein a power output of said first amplifying element is judged based on an output current from an output terminal of said second amplifying element.

2. A high frequency power amplifying circuit according to claim 1, wherein a plurality of said first amplifying elements are provided and a number of said first amplifying elements to be activated in parallel in response to control signals from said power control circuit is increased or decreased.

3. A high frequency power amplifying circuit according to claim 1, wherein a plurality of said first amplifying elements are provided, each having its own size, and one of said plurality of said first amplifying elements is selected and activated in response to an output control signal corresponding to a control signal from said power control circuit.

4. A high frequency power amplifying circuit according to claim 2, wherein a plurality of said second amplifying elements are provided, each corresponding to one of said first amplifying elements, and said plurality of second amplifying elements are activated in parallel in accordance with said first amplifying elements activated in response to the control signals from said power control circuit.

5. A high frequency power amplifying circuit according to claim 3, wherein a plurality of said second amplifying elements are provided, each corresponding to one of said first amplifying elements, and said second amplifying element corresponding to one of said first amplifying elements activated in response to the control signal from said power control circuit is activated.

6. A high frequency power amplifying circuit according to claim 4, wherein said first amplifying elements and said second amplifying elements are formed on an identical semiconductor substrate.

7. A high frequency power amplifying circuit according to claim 5, wherein said first amplifying elements and said second amplifying elements are formed on an identical semiconductor substrate.

8. A high frequency power amplifying circuit according to claim 1, wherein an output current output from an output terminal of said second amplifying element selectively flows through a plurality of series resistors under control of a switch controlled by an output current detection sensitivity switching signal.

9. A high frequency power amplifying circuit according to claim 1, wherein a plurality of said second amplifying elements are provided having output terminals connected in common, and said control signal is selectively supplied under control of a switch controlled by an output current sensitivity switching signal.

10. A high frequency power amplifying circuit according to claim 1, wherein an input signal supplied to an input of said first amplifying element is supplied also to an input terminal of said second amplifying element and an output current of said second amplifying element is a detected current obtained through conversion of the input signal to a direct current.

11. A high frequency power amplifying circuit according to claim 1,
wherein said first amplifying element constitutes an output stage amplifier of a multi-stage amplification circuit whose preceding stages are composed of one or more amplifying elements connected in tandem,
wherein said second amplifying element is provided corresponding to the first amplifying element constituting said output stage amplifier, and
wherein a control signal generated by said power control circuit is supplied to the amplifiers vertically connected in the stages.

12. A high frequency power amplifying circuit according to claim 1, wherein said first and second amplifying elements are MOSFETs.

13. A high frequency power amplifying circuit according to claim 1, wherein said first amplifying element is operated by a battery voltage.

14. A mobile communication apparatus-comprising:
a high frequency power amplifying circuit including a first amplifying element, a second amplifying element of the same structure as said first amplifying element, an element size of said second amplifying element being 1/M of said first amplifying element, and a power control circuit supplying an identical bias voltage to said first amplifying element and said second amplifying element, wherein a power output of said first amplifying element is judged based on an output current from an output terminal of said second amplifying element;
a control circuit supplying an output power control instruction to said power control circuit based on a control signal included in a signal received from a base station; and
a rechargeable battery supplying an operation voltage to an electric circuit including said high frequency power amplifying circuit and said control circuit.

15. A mobile communication apparatus according to claim 14, wherein said battery is a lithium ion battery.
